(19) United States
(12) Patent Application Publication
(10) Pub. No.: US 2009/0213409 A1
(43) Pub. Date: Aug. 27, 2009

(54) IMAGE PROCESSING APPARATUS

(75) Inventors: Naoya Arifuku, Osaka (JP); Kazuma Ogawa, Nara (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/393,476

(22) Filed: Feb. 26, 2009

(30) Foreign Application Priority Data
Feb. 27, 2008 (JP) 2008-045381

(51) Int. Cl. G06F 3/12

(52) U.S. Cl. 358/1.13

(57) ABSTRACT

Provided is an image processing apparatus 100 that is capable of deleting an unnecessary peculiar page reliably and processing only a page having an effective image efficiently.

A document reading apparatus 100 is constituted of a control section 101, a scanner section 102, an image processing section 103, a storage section 104, a communication section 105, an operation panel section 106, a driver 107 for driving and controlling a document scanning section driving motor 107a, and a driver 108 for driving and controlling a document feeding roller driving motor 108a.

The control section 101 has a detection function for detecting a page having a peculiar image from image data, a display function for causing a display section 106a to display an image of the detected peculiar page, and a delete function for deleting the peculiar page based on input from a user. The control section 101 has a skip mode for, with a use of these functions, detecting a peculiar page to determine whether or not the peculiar page is deleted based on an instruction from the user.

### BACKGROUND OF THE INVENTION

1. Field of the Invention

The present invention relates to an image processing apparatus having a scanner function for reading a document.

2. Description of the Related Art

For this kind of image processing apparatus, various types have been proposed conventionally. An example thereof includes a multifunctional peripheral, in which an image reading apparatus having a scanner function for reading a document and an image forming apparatus having a printer function or an electronic filing function for outputting an image of a read document as an electronic data file are integrally provided.

Further, in recent years, there has been proposed an image processing apparatus having two reading sensors provided in an image reading apparatus, for reading images on front and rear faces of a document simultaneously to process the images.

By using this kind of image processing apparatus, user's operability has been significantly improved, which, however, induced a new problem.

For example, when handling a double-sided document having images on front and rear faces thereof and a single-sided document having an image only on one face thereof (blank image on the other face) in a mixed state, a problem is caused that all documents are processed as a double-sided document. That is, a user usually selects on an operation panel of the image processing apparatus whether a target document to be read is a single-sided document or a double-sided document, then the image processing apparatus starts reading the document according to the selected kind of the document. Accordingly, when a target document to be read is selected as a double-sided document, regardless of a single-sided document or a double-sided document, the image processing apparatus reads the document as a double-sided document, thus reads a blank face of a single-sided document at the same time. As a result, when the read images are outputted as they are, the image of a blank page is unnecessarily output.

Hence, Japanese Patent Laid-Open No. 08-088704 discloses an image processing apparatus, in which, based on quantity of effective image information of each page calculated by an MPU (Micro Processing Unit), a peculiar page (for example, a blank sheet page) is recognized from series of image data detected by detecting means, the recognized peculiar page is sequentially skipped, and only image data serving as an effective image is outputted to an LBP (Laser Beam Printer).

Japanese Patent Laid-Open No. 2004-248326 discloses an image processing apparatus, in which based on image data for each page of a document, whether or not a peculiar page (for example, a blank sheet page) is determined for each page, and when determined as a page having usual image data, the read image data is recorded in a memory to copy, whereas when determined as a peculiar page (for example, a blank sheet page), recording image data of the page in the memory and copying thereof are stopped.

Japanese Patent Laid-Open No. 2006-094023 discloses an image processing apparatus provided with an image reading reader that reads an image of a document and a blank sheet detection unit, in which when an image read by the blank sheet detection unit is a peculiar page (for example, a blank sheet page), a display unit displays a blank-sheet detection informing screen and a voice output unit outputs a voice guide notifying that a blank sheet is detected.

By the way, image processing apparatuses described in Japanese Patent Laid-Open Nos. 08-088704, 2004-248326, and 2006-094023 are constituted so that read image data is temporarily stored in a memory, a control section determines whether or not the image data in the memory is a peculiar page, and in the case of a peculiar page, it is deleted without displaying to a user. That is, the user can not confirm the peculiar page visually.

Thus, there is a problem that, for example, even a page having a necessary image for the user is deleted as an unnecessary page by an erroneous operation of an image reading section.

In view of the above described circumstance, it is an object of the present invention to provide an image processing apparatus that is capable of deleting an unnecessary peculiar page reliably and processing only a page having an effective image efficiently.

### SUMMARY OF THE INVENTION

In order to attain the above described object, the present invention includes an input section for inputting an image in a page unit, a display section for displaying the image, and a control section for detecting a peculiar page from the image inputted from the input section to control the display section, in which when detecting the peculiar page, the control section causes the display section to display the peculiar page so that a user is capable of confirming whether or not the peculiar page is necessary.

Here, a peculiar page refers to a page having an abnormal image, for example, such as a plain (blank) image, a distorted image, or a skewed image with respect to a recording sheet.

According to the above described configuration, when an image in a page unit is inputted from the input section, the control section analyzes the inputted image. Specifically, the control section determines whether or not there is included an abnormal image in the inputted image. When an abnormal image is detected in the inputted image, the control section detects a page having the abnormal image as a peculiar page.

When the peculiar page is detected, the control section causes the display section to display the peculiar page. For example, the control section causes the display section to display an image of the peculiar page. Alternatively, the control section causes the display section to display a page number of the peculiar page. Yet alternatively, the control section causes the display section to display a thumbnail image of the peculiar page.

According to the above described configuration, the user is capable of confirming the peculiar page from the display section in detail. Thereby, for example, in the case of a page having less image, the control section is likely to erroneously recognize it as a peculiar page. However, since the peculiar page is displayed on the display section, the user is capable of performing determination of necessity.

When causing the display section to display the image of the peculiar page, the control section may display a page number of the peculiar page together. This makes it easier for the user to confirm a second page such as a rear side of a cover and to determine necessity of the peculiar page.

When a plurality of peculiar pages are detected, the control section may display the plurality of peculiar pages as a list. In this case, the list is preferably caused to display page numbers of the peculiar pages. According to this configuration, the control section is capable of informing the user of the peculiar pages at a time. This makes it possible for the user to confirm that which page is a peculiar page at a glance and to thereby shorten a confirming operation.

The control section causes the display section to display images of continuous pages including the peculiar page. For example, the control section causes the display section to display images of the previous and next pages to the peculiar page. According to this configuration, when determining whether or not the peculiar page is necessary, the user is capable of confirming the previous and next pages to the peculiar page. This makes it possible, after determining a state in output, such as double-sided printing or single-sided printing, to determine whether or not the peculiar page is necessary.

When the user determines that the peculiar page is not necessary and selects a delete button, for example, the control section deletes the peculiar page. Specifically, the image processing apparatus includes an operation section for receiving input of an operational instruction. When the user performs a delete operation from the operation section, the control section deletes the peculiar page and thereafter outputs the inputted pages with the peculiar page not included. When the user does not perform the delete operation from the operation section, the control section outputs the inputted pages, that is, all pages including the peculiar page without deleting the peculiar page.

As described above, according to the present invention, since the display section displays a detected peculiar page, it is possible for a user to determine necessity while visually viewing an image of the peculiar page. This makes it possible, even when erroneous recognition occurs in the control section, to determine a necessary page or an unnecessary page reliably. It is also possible, when performing processing such as printing for a read image, to reduce a recoding sheet. Furthermore, even when a large volume of documents are copied, it is not necessary to perform modification after processing, thus making it possible to save time in total.

### BRIEF DESCRIPTION OF THE DRAWINGS

FIG. 1 is a cross-sectional view of an image processing apparatus according to the present embodiment;

FIG. 2 is a block diagram of the image processing apparatus;

FIG. 3 is a view showing a page recognition screen;

FIG. 4 is a view showing a preview screen for an image of a peculiar page;

FIG. 5 is a view showing a preview screen for images of the previous and next pages to a peculiar page; and

FIG. 6 is a flowchart of a peculiar page skipping mode.

### DETAILED DESCRIPTION OF THE PREFERRED EMBODIMENTS

An image processing apparatus of the present invention will hereinafter be described in detail. Note that, for convenience of explanation, an image processing apparatus of the present embodiment will be described as an image reading apparatus 100 for reading an image.

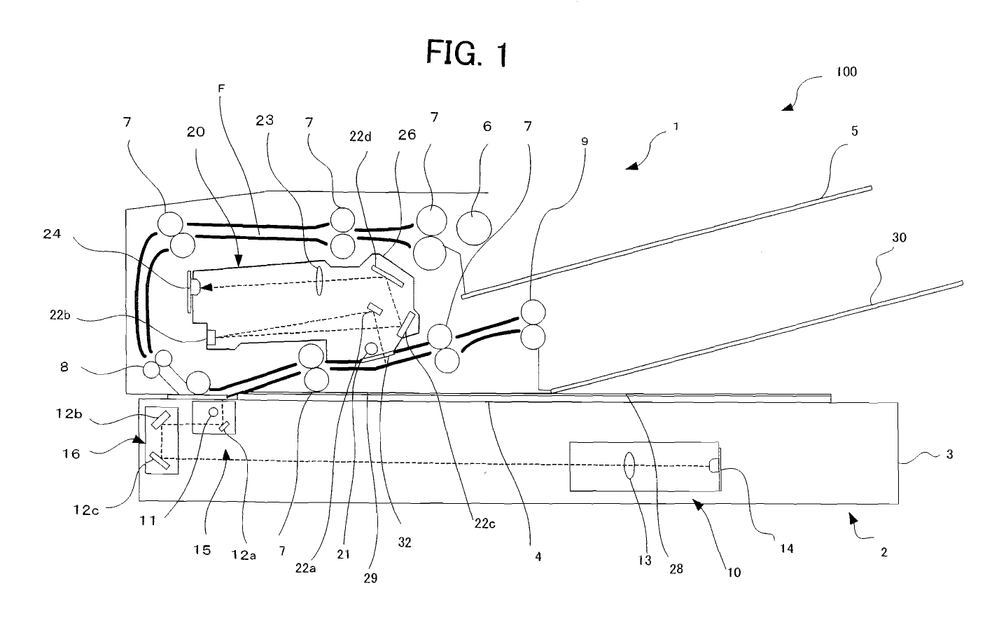

The image reading apparatus 100 includes, as shown in FIG. 1, an automatic document feeder (ADF) 1 for automatically feeding a document along a document feeding path F, a first image reading section 10 for reading an image on the front side of the fed document, and a second image reading section 20 for reading an image on the rear side of the fed document.

The first image reading section 10 is an image reading section having a demagnification optical system that is mainly constituted of a light source 11, a first mirror 12a, a second mirror 12b, a third mirror 12c, a lens 13, and a CCD (Charge Coupled Devices) 14. The first image reading section 10 includes a light source unit 15 for holding the light source 11 and the first mirror 12a, and a mirror unit 16 for holding the second mirror 12b and the third mirror 12c.

The light irradiated by the light source unit 15 and then reflected on a document is reflected on the first mirror 12a provided in the light source unit 15, and then its optical path is converted at an angle 180° by the second mirror 12b and the third mirror 12c in the mirror unit 16. The light reflected on the third mirror 12c is focused through the lens 13 on the CCD 14, to be thus converted into electric image data.

The second image reading section 20 is an image reading section having a demagnification optical system that is constituted of a light source 21, a first mirror 22a, a second mirror 22b, a third mirror 22c, a fourth mirror 22d, a lens 23, and a CCD (Charge Coupled Devices) 24. The second image reading section 20 is unified into a single assembly by storing the light source 21, the first to fourth mirrors 22a, 22b, 22c and 22d, the lens 23, and the CCD 24 inside of a unit housing 26.

The unified second image reading section 20 is disposed so as to be housed in the document feeding path F curved in a substantial U shape. Note that, the light source 21, the lens 23, and the CCD 24 in the second image reading section 20 are the same as ones constituting the first image reading section 10.

The second image reading section 20 reads an image on the rear side of a document fed on the document feeding path F, when a user requests double-sided reading.

Specifically, after an image on the front side of the document is read by the first image reading section 10, the document passes under the light source 21 of the second image reading section 20 while the document is fed toward a paper ejection tray 30 along the document feeding path F. During this time of period, the light source 21 of the second image reading section 20 irradiates the rear side of the document with the light. The light reflected on the rear side of the document passes through a reading window 32 made of a transparent member such as a glass, and its optical path is sequentially converted by the first to fourth mirrors 22a, 22b, 22c and 22d, and then the light is focused through the lens 23 on the CCD 24, to be thus converted into electric image data.

The image reading apparatus 100 is mainly constituted of an ADF 1 that houses the second image reading section 20 and a main scanning section 2 that houses the first image reading section 10. The ADF 1 and the main scanning section 2 are coupled by a hinge (not shown).

The ADF 1 can be opened and closed with respect to the main scanning section 2 by rotation of the hinge. The ADF is mainly constituted of a taking-in roller 6 for taking documents placed on a document table 5 page by page into the ADF 1, a plurality of pairs of feeding rollers 7 for feeding the taken-in documents along the document feeding path F, a resist roller 8 for adjusting a sheet feeding timing, and a paper ejection roller 9 for ejecting the document whose image is read to a paper ejection tray 30.

The lower surface of the ADF 1 serves as a pressing plate 28 for pressing the documents to be read placed on a platen plate 4 in the main scanning section 2 from above. The pressing plate 28 serves as a cover 29 capable of opening a part facing to the light source 21 in the first image reading section 20.

The main scanning section 2 is mainly constituted of a housing 3, the platen plate 4 made of a translucent glass plate, and the first image reading section 10 contained in the housing. The main scanning section 2 copes with both image reading methods including a document fixing method where a document is placed on the platen 4 by a user and an image of the document is read, and a document moving methods where an image of a document is read while the document is automatically fed by the ADF 1.

When the image of the document is read by the document fixing method, the light source unit 15 and the mirror unit 16 are moved to home positions, respectively, according to the document fixing method. Then, the light source unit 15 is moved at a constant speed in a sub scanning direction (in a lateral direction relative to a paper surface) to scan the image of the document while irradiating the document with the light. At the same time, the mirror unit 16 is moved at a movement speed half the movement speed of the light source unit 15 also in the sub scanning direction.

When the image of the document is read by the document moving system, the light source unit 15 and the mirror unit 16 stay at the home positions, and the light source 11 irradiates, with the light, the document fed over the home positions by the ADF 1, to thereby scan the image. The light reflected on the front face side of the document is reflected on the first mirror 12a and thereafter its optical path is converted at an angle of 180° by the second mirror 12b and the third mirror 12c in the mirror unit 16, and the light is focused through the lens 13 on the CCD 14, to be thus converted into electric image data, like in the above mentioned document fixing system.

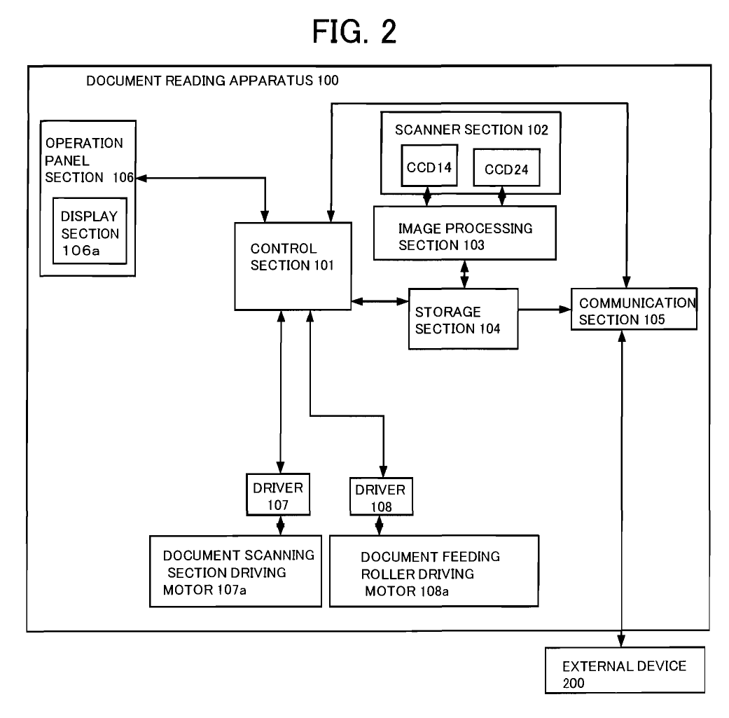

The document reading apparatus 100 is mainly constituted of, as shown in FIG. 2, a control section 101, a scanner section 102, an image processing section 103, a storage section 104, a communication section 105, an operation panel section 106, a driver 107 for driving and controlling a document scanning section driving motor 107a, a driver 108 for driving and controlling a document feeding roller driving motor 108a.

The scanner section 102 is an input section for inputting an image in a page unit, and is constituted of the ADF 1, the first image reading section 10, the second image reading section 20, and each scanning section. Note that, each of the CCDs 14 and 24 in the first image reading section 10 and the second image reading section 20 is a CCD having a demagnification optical system, but may be a CIS (Contact Image Sensor) having an equal-magnification optical system.

The image processing section 103 converts optical data read by the first image reading section 10 or the second image reading section 20, that is, a read image, into electric image data in a page unit.

The storage section 104 is constituted of, for example, a RAM, an EEPROM, a hard disk, an MO and the like. The storage section 104 stores data to be processed, that is, image data in a page unit or various contents of inputted instructions.

The communication section 105 performs two-way communication with an external device 200 such as a computer or a printer connected directly or through a network. The communication section 105 transmits image data applied with image processing at the image processing section 103 to the external device 200. In addition, the communication section 105 is provided with a memory for developing data transmitted from the external device 200 into data that can be handled by the present apparatus.

The operation panel section 106 is an operation section for receiving inputting of an operational instruction from a user, and includes a display section 106a for displaying a read image, a key for operation, a ROM for storing a program describing processing of the operation section 106, data for display, fonts for display and the like, and a RAM as a storage region for working.

The display section 106a includes a liquid crystal panel for displaying an image and a liquid crystal driver for driving and controlling the liquid crystal panel. The display section 106a displays an inputted image based on an instruction from the control section 101. The display section 106a having an electrostatic type touch panel is formed with an operation button for operating input.

The touch panel detects presence/absence of the input by a conventional electrostatic type detection sensor (not shown). Specifically, the surface of the touch panel is pressed to contact with electrodes of the depressed part, thereby letting a current flow. When the current flows, the detection sensor detects input. In addition, the detection sensor detects a position where the current flows, that is, a pressed position. Then, the detection sensor outputs the detected position to the control section 101.

The key is connected through a key matrix to the control section 101. The key is used for a file selecting work by a user, and the like.

The operation panel section 106 is disposed on the upper surface of a part where the main scanning section 2 is extended to be nearer than the ADF 1. The operation panel section 106 is used for inputting an operation mode (specification of single-sided reading or double-sided reading) in reading a document.

The document scanning section driving motor 107a is a motor for moving the light source unit 15 and the mirror unit 16 at an appropriate speed in the sub scanning direction, when a document image is read by the document fixing method. The document scanning section driving motor 107a is appropriately driven and controlled by the driver 107 with control from the control section 101.

The document feeding roller driving motor 10 8a is a motor for driving each of the taking-in roller 6, the feeding rollers 7, the resist roller 8, the paper ejection roller 9 and the like, which are disposed on the document feeding path F. The document feeding roller driving motor 108a is appropriately driven and controlled by the driver 108 with control from the control section 101.

The control section 101 controls an operation of the entire apparatus. The control section 101 is constituted of a CPU, a ROM, a RAM and the like.

In processing and outputting an inputted image, the control section 101 has a detection function for detecting a page having a peculiar image from image data, a display function for displaying an image of the detected peculiar page on the display section 106a, and a delete function for deleting a peculiar page based on input from a user. Using these functions, the control section 101 detects a peculiar page and executes a skip mode for confirming whether the peculiar page is deleted or not.

The detection function is a function for detecting an abnormal image such as a plain (blank) image, a distorted image, or a skewed image with respect to a recording sheet, among inputted images. The control section 101 processes inputted images in a page unit. Specifically, the control section 101 extracts image data in a page unit stored in the storage section 104 and detects presence/absence of a character, a figure and the like from the extracted image data. Alternatively, the control section 101 extracts an edge from the extracted image data and detects whether the edge is inclined or distorted.

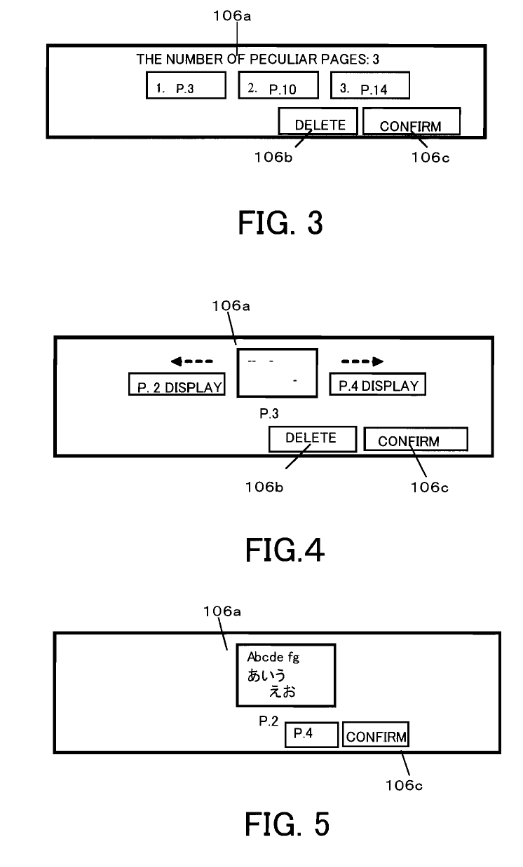

The display function is a function for displaying a peculiar image detected by the detection function on the display section 106a, as shown in FIGS. 3 to 5. Specifically, the control section 106 displays a page recognition screen (refer to FIG. 3) for displaying a page number of the detected peculiar image, a peculiar page preview screen (refer to FIG. 4) for displaying the image of the peculiar page, and a previous-and-next page preview screen (refer to FIG. 5) for displaying preview of images of the previous and next pages to the peculiar page on the display section 106a.

The page recognition screen displays a peculiar page detected by the control section 101. For example, when there is only one peculiar page, a page number of the page or an image of the page is displayed. When there are a plurality of peculiar pages, page numbers of all of the peculiar pages are displayed as a list.

The peculiar page preview screen displays an image of a peculiar page and page numbers of previous and next pages to the page, which are selected by a user in the page recognition screen. Specifically, when a page number of a peculiar page that a user wants to see is selected in the page recognition screen, the control section 101 displays a preview screen of the peculiar page.

The previous-and-next page preview screen displays images of the previous and next pages to the peculiar page selected by the user in the peculiar page preview screen. Specifically, when page numbers of previous and next pages to the page that the user wants to see are selected in the peculiar page preview screen, the control section 101 displays images of the selected pages.

In the delete function, whether or not a peculiar page is necessary is determined based on input from a user, and when determined to be unnecessary, image data relating to the page is deleted from the storage section 104. When determined to be necessary, image data relating to the page is retained in the storage section 104.

Specifically, a delete button 106b and a confirmation button 106c are displayed on the display section 106a. When the user operates the delete button 106b, the control section 101 deletes the image data of the selected peculiar page from the storage section 104.

For example, as shown in the screen of FIG. 3, when the delete button 106b is operated while page numbers of a plurality of peculiar pages being displayed, the control section 101 deletes all image data of the displayed peculiar pages from the storage section 104. As shown in the screen of FIG. 4, when the delete button 106b is operated while the selected peculiar page being displayed, the control section 101 deletes image data of the selected peculiar page from the storage section 104. When the selected page is deleted, the control section 101 excludes a page number of the deleted peculiar page and displays page numbers of other peculiar pages.

When the confirmation button 106c is operated by the user, a screen displayed immediately before the actual screen is displayed. For example, when the confirmation button 106c is operated while displaying the screen of FIG. 4 through the screen of FIG. 3, the control section 101 displays the screen of FIG. 3. When the confirmation button 106c is operated while displaying the screen of FIG. 5 through the screen of FIG. 4, the control section 101 displays the screen of FIG. 4.

Note that, when the confirmation button 106c is operated in the screen of FIG. 3, the control section 101 determines that the detected peculiar page is not deleted and outputs image data stored in the storage section 104, through the communication section 105, to the external device 200.

The control section 101 outputs image data through the communication section 105 to the external device 200. Specifically, when the peculiar page is deleted, the control section 101 outputs image data excluding image data of the page. When a plurality of peculiar pages are deleted, image data excluding all of the deleted pages is outputted. When there is no peculiar page deleted, image data stored in the storage section 104 is outputted as it is.

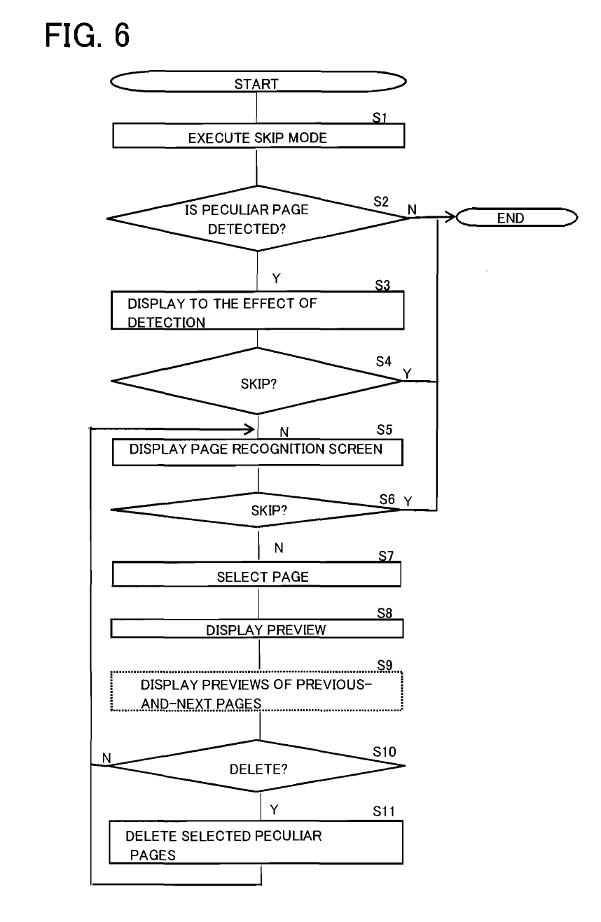

Next, a specific operation of a skip mode will be described with reference to the flowchart of FIG. 6. Note that, for convenience of explanation, page numbers of pages detected as a peculiar page are, P3, P10 and P14, as shown in FIG. 4, and among them, P3 is a peculiar page selected by a user.

When a document having an image is set on the ADF 1 and an operation input is made by a user through the operation panel section 106 to execute processing such as copying, the control section 101 starts a skip mode (S1).

The document is fed from the ADF 1 and an image of the document is read by the image reading sections 10 and 20. The read image is converted by the image processing section 103 to image data, and stored in the storage section 104. The control section 101 extracts stored image data and detects a peculiar page based on presence/absence of a character, a figure or the like among the image data.

When no peculiar page is detected (N at S2), the control section 101 stores the image of the document in the storage section 104 and thereafter outputs through the communication section 105 to the external device 200. When output processing is finished, the image reading apparatus 100 is put into a standby state.

When a peculiar page is detected (Y at S2), the control section 101 displays the detection of the peculiar page on the display section 106a (S3). When the user selects the skip mode (Y at S4), that is, when the user selects to output all pages including the peculiar page, the control section 101 outputs image data including the image of the peculiar page through the communication section 105 to the external device 200. When output processing is finished, the image reading apparatus 100 is put into a standby state.

When the user selects the confirmation of a peculiar page (N at S4), the page recognition screen of a peculiar page as shown in FIG. 3 is displayed (S5). When the confirmation button 106c is operated by the user, that is, when the skip is selected (Y at S6), the control section 101 outputs image data including the image of the peculiar page through the communication section 105 to the external device 200. When output processing is finished, the image reading apparatus 100 is put into a standby state.

When the confirmation button 106c is not operated by the user (N at S6), but a page number of the peculiar page is operated by the user (S7), that is, when a page number of one peculiar page is selected by the user among page numbers of peculiar pages displayed on the display section 106a, the control section 101 displays a preview screen of the selected peculiar page as shown in FIG. 4 (S8).

While the screen of FIG. 4 is displayed, when the user selects page numbers of previous and next pages to the peculiar page and operates the confirmation button 106c, an image of the selected page is displayed (S9).

In the peculiar page preview screen, when the user operates the delete button 106b, the control section 101 deletes image data relating to the selected peculiar page from the storage section 104, and then displays page numbers of other peculiar pages excluding the deleted peculiar page on the page recognition screen (S5).

In the page recognition screen, when the user operates the confirmation button 106c, image data including images of the remaining peculiar pages is retained in the storage section 104 and the image data is outputted through the communication section 105 to the external device 200. Then, the image reading apparatus 100 is put into a stand-by state.

In the page recognition screen, when the user operates the page number of the peculiar page (S7), the control section 101 executes processing of S8 to S11 to the selected peculiar page.

In the peculiar page preview screen, when the user operates the confirmation button 106c (N at S10), that is, when the peculiar page is not deleted, the control section 101 retains image data relating to the selected peculiar page in the storage section 104, and displays page numbers of other peculiar pages excluding the stored peculiar page on the page recognition screen (S5).

In the page recognition screen, when the user operates the confirmation button 106c (Y at S6), image data including images of the remaining peculiar pages is retained in the storage section 104 and the image data is outputted through the communication section 105 to the external devices 200. Then, the image reading apparatus 100 is put into a stand-by state.

In the page recognition screen, when the user operates a page number of a peculiar page (S7), the control section 101 executes processing of S8 to S11 to the selected peculiar page.

This processing is executed for each detected peculiar page. When the confirmation is finished with respect to all of the detected peculiar pages, the skip mode is finished and the image reading apparatus 100 is put into a stand-by state.

As a result, the user is able to confirm preview of the detected peculiar pages, which enables the user to make an appropriate determination of whether to delete a peculiar page after the confirmation. In addition, even in the case of erroneous detection, it is possible to prevent a necessary page from being deleted.

The present invention will not be limited to the above described embodiments and many modifications and alterations can certainly be made to the above described embodiments within the scope of the present invention. In the present embodiment, description has been given for a copy mode where inputted image data is outputted, for example, on a paper medium, but it may be a document filing mode where inputted image data is outputted as an electronic data file, or a fax mode where inputted image data is transmitted (outputted) through a telephone line to the outside.

In the present embodiment, description has been given with the image reading apparatus, but not limited thereto, and it may be a multifunctional peripheral in which an image reading apparatus and an image forming apparatus for printing a read image on a recording sheet are integrally constituted. It may also be a FAX machine for performing facsimile communication.

In the present embodiment, display of a peculiar page is represented with a page number in the page recognition screen, but not limited thereto, and for example, a screen of the peculiar page may be displayed. Alternatively, all of images of read documents may be displayed, and for example, a color or a size of an image of a peculiar page may be displayed so as to be different from other images.

In the present embodiment, the peculiar page preview screen displays an image for a peculiar page and page numbers for previous and next pages to the peculiar page, but not limited thereto, and may display the image of the peculiar page and images of the previous and next pages to the peculiar page. In this case, the images may be displayed as thumbnail images.

In the present embodiment, input of an image is assumed as a current image, but not limited thereto, and for example, it may be image data inputted directly or from an external device such as a personal computer connected through a network.

In the present embodiment, an inputted image is converted to image data in the image processing section, and then stored in the storage section, but not limited thereto, and for example, the image data may be stored temporarily in a volatile memory, and after determination of whether to delete a peculiar page, a page determined to be necessary may be stored in the storage section.

In the present embodiment, the delete button is displayed on the display section, but not limited thereto, and for example, may be provided in a key of the operation panel section.

What is claimed is:

1. An image processing apparatus comprising:
an input section for inputting an image in a page unit;
a display section for displaying the image; and
a control section for detecting a peculiar page from the image inputted from the input section to control the display section, wherein
when detecting the peculiar page, the control section causes the display section to display the peculiar page so that a user is capable of confirming whether or not the peculiar page is necessary.

2. The image processing apparatus according to claim 1, wherein:
the control section causes the display section to display an image of the peculiar page.

3. The image processing apparatus according to claim 2, wherein:
the control section causes the display section to display images of continuous pages including the peculiar page.

4. The image processing apparatus according to claim 3, wherein:
the control section causes the display section to display images of the previous and next pages to the peculiar page.

5. The image processing apparatus according to claim 1, wherein:
when detecting a plurality of peculiar pages, the control section causes the display section to display the plurality of peculiar pages as a list.

6. The image processing apparatus according to claim 5, wherein:
the control section causes the display section to display page numbers of the peculiar pages.

7. The image processing apparatus according to claim 1, wherein:
when displaying each page, the control section also causes the display section to display each page with the page number thereof.

8. The image processing apparatus according to claim 1, wherein:
when the peculiar page is selected as unnecessary by the user, the control section deletes the peculiar page.

9. The image processing apparatus according to claim 8 comprising an operation section for receiving input of an operational instruction, wherein:
when the user performs a delete operation, the control section outputs an image of the next page to the peculiar page, and when the user does not perform the delete operation, the control section outputs an image of the peculiar page without deleting the peculiar page.
